(19) United States
(12) Patent Application Publication
(10) Pub. No.: US 2015/0060698 A1
(43) Pub. Date: Mar. 5, 2015

(54) FLUORESCENCE MICROTITRE PLATE READER

(71) Applicant: OCULER LIMITED, Ballina (IE)

(72) Inventors: Guy Mozolowski, Ballina (IE); James Hynes, Ovens (IE)

(73) Assignee: OCULER LIMITED, Ballina (IE)

(21) Appl. No.: 14/388,968

(22) PCT Filed: Apr. 1, 2013
(86) PCT No.: PCT/EP2013/056846

§ 371 Date: Sep. 29, 2014

(30) Foreign Application Priority Data
Mar. 29, 2013 (GB) 1205607.3

(51) Int. Cl. G01N 21/64

(52) U.S. Cl. CPC G01N 21/64; G01N 2201/06113; G01N 2201/062
USPC 250/459.1; 250/461.1; 250/458.1; 250/216

(57) ABSTRACT

A fluorescence microtitre plate reader comprises a plate reader body (2) having a base (3), top (5) and sidewalls (4), the top of the plate reader comprising at least one seat (6) dimensioned for receipt of a microtitre plate (7), the at least one seat defining an aperture (8) in the top of the plate that substantially corresponds to a base of the plate. The plate reader also includes means for illuminating wells of a microtitre plate with light from beneath the plate having an excitation wavelength, and a camera (10) and lens (11) assembly for capturing light emitted by the wells of the microtitre plate and generating a digital image, in which regions of light intensity of the image correspond to wells of the microtitre plate. An optical system is disposed within the plate reader body for expanding the distance to image plane of light, the optical system comprising a first mirror (15) disposed to receive light from the wells of the microtitre plate and reflect the light to second mirror (16) which is disposed to reflect incident light to the camera lens. The means for illumining the wells of the microtitre plate comprises a ring light (12) that embraces the camera and lens assembly.

### TECHNICAL FIELD

The invention relates to a fluorescence microtitre plate reader, and a method for detecting fluorescence intensity of light emitted from a well of a microtitre plate.

### BACKGROUND TO THE INVENTION

Fluorescence microplate readers have been described previously for use in determining aerobic bacterial numbers in samples. These devices generally comprise an optical illumination system and optical detection system that are located on opposite sides of the microplate. Such systems operate on the basis of trans-fluorescense, where the light passes through the sample before being detected. This system is unworkable where the test matrix is opaque i.e. milk. Generally, the detection system for plate readers comprises a photomultiplier tube which is adapted to detect fluorescence intensity of light emitted by a well. Thus, the system requires use of a multiplier tube for each well of the plate, and processing means for collecting data from each photomultiplier tube and analysing the separate streams of data. Plate readers are also known that employ CCD cameras to generate a digital image of the plate, and detect intensity of light emitted by wells of the microtitre plate from the digital image. With such plate readers, due to the confined space within the plate reader body, the camera is located relatively close to the plate. Due to proximity of the camera and the plate, a powerful lens is required to focus the light that is emitted by the plate onto the camera.

Classically, in multiplate reading systems the optics will remain stationary and the test plate is moved to the optics, which necessitates extensive investment in robotics to automate the movement of plates. By inverting the situation such that the optics move but the plates remain relatively stationary negates the need to develop complicated robotic handling mechanisms. However the packaging of the optics into a mobile ‘optics box’ limits the amount of space available in which to construct a viable optical detector system.

It is an object of the invention to overcome at least one of the above-referenced problems.

### STATEMENTS OF INVENTION

In a first aspect, the Applicant has provided a microplate reader that in one embodiment is suitable for detecting fluorescence intensity of light emitted from a well of a microtitre plate. The microplate reader detects fluorescence intensity by generating a digital image of an underside of the plate. The Applicant has obviated the requirement for a powerful lens systems by providing an optical system within the confined space of a plate reader optics box adapted to increase the distance to image focal length. Typically, the optical system comprises two reflecting surfaces, a first of which reflects light emitted through a base of the plate along a first light path, and a second which reflects light incident along the first light path to the camera along a second light path. The Applicant has also provided a system in which light the illuminating light and emitted light travels along a substantially co-axial path along their length (ie. they are substantially co-axial and substantially co-planar. This is achieved by providing a ring light that embraces the camera and lens assembly.

Thus, in a first aspect, the invention provides a microtitre plate reader comprising:
a plate reader body having a base, top and sidewalls, the top of the plate reader optionally comprising at least one seat dimensioned for receipt of a microtitre plate, the at least one seat defining an aperature in the top of the plate that substantially corresponds to a base of the plate;
means for illuminating wells of a microtitre plate with light from beneath the plate;
a camera and lens assembly for capturing light emitted by the wells of the microtitre plate and generating a digital image, in which regions of light intensity of the image correspond to wells of the microtitre plate; and
optionally, an optical system disposed within the plate reader body for expanding the distance to image plane of light (object distance) and comprising at least two mirrors,
   characterised in that the means for illuminating the wells of the microtitre plate comprises a ring light that embraces the camera and lens assembly.

The shape of the ring light and its position around the camera and lens assembly provides a favourable lighting geometry leading to enhanced uniformity of illumination across the sample plate. It also obviates the need for a microlens array, multiple light sources, and optical fibre-based systems, that are commonplace in devices of the prior art, and provides for excitation (illumination) and detection (emitted) light that is substantially co-axial, therefore obviating the need for a beam splitter. The ring light may embrace the lens or the camera (preferably the lens), or both, or it may be positioned slightly proximally or distally of the camera lens assembly.

In this specification, the term “ring light” should be understood to mean a light source that is capable of partially or fully embracing the camera and lens assembly, preferably the lens. They generally comprise a plurality of individual light sources, for example LED' s, arranged in an annular housing. Ring lights are sold by Rotolights, Inc (www.rotolights.com) and F&V (www.fvlighting.com).

Preferably, the ring light embraces (ideally fully embraces) the lens. Typically, the ring light emits UV light, ideally UV light having a peak wavelength of 370-390 nm, ideally about 380 nm. Suitably, the ring light is an LED ring light, preferably a LED ring light that emits UV light having a peak wavelength of 370-390 nm, ideally about 380 nm. UV emitting LEDs provide a relatively cheap, efficient method of illuminating a sample plate with a narrow band of excitation wavelengths without having to resort to a monochromatic/high coherence source such as a laser.

Typically, a first mirror is disposed to receive light from the wells of the microtitre plate and reflect the light to second mirror which is disposed to reflect incident light to the camera lens. The optical system addresses the problem of the confined space within the plate reader body by providing a means for expanding the distance to image plane of light (object distance) being emitted from the base of the wells of the microtitre plate. The increased distance to image plane of light obviates the need for a powerful and expensive lens which otherwise would be required when the lens are plate are located so close together.

Suitably, the camera, and ideally also the illumination means, are disposed on a sidewall of the plate reader body. In other embodiments, the camera and lens assembly and illumination means may be disposed on a base of the plate reader body, and with the two mirrors suitably arranged to direct illumination and emitted light along a substantially co-axial light path between the lens and the plate.

Preferably, the camera is a CCD camera, ideally a cooled CCD camera. CCD cameras (chips) are exceptionally sensitive, however they are not always as discerning/selective as other means of optical detection. In particular they are unable to distigush between incident photons and thermal electrons. As a result taking extended exposures, as is necessary in low light, can be subject to excessive noise due to the presence of thermal electrons. In order to mitigate this effect the CCD chip is encased in a quartz vacuum chamber which is connected to a thermoelectric cooling system, this reduces the temperature of the chip to −50° C. below ambient, eliminating any issues with noise caused by thermal electrons.

In one embodiment, the camera is disposed on a sidewall of the plate reader body, and wherein the mirrors are disposed with the plate reader body such that the first light path and second light path are generally located in the same plane and generally perpendicular to each other. This arrangement provides an effective way of expanding the distance to image focal length, and effectively allows emitted light to reflect off the first mirror across the plate reader body to the second mirror, where the light is reflected in a separate direction towards the camera lens.

Suitably, the illumination light and emitted light is substantially co-axial and optionally substantially co-extensive. This means that the two light signals (illumination and emission) extend along paths that are generally parallel and of generally the same length.

In a preferred embodiment, the plate reader body comprises a baffle adapted to confine the light entering the lens to that reflected off the second mirror. Typically, the baffle comprising a tube one end of which is positioned adjacent the lens (and ideally embraces the lens) and a second end of which is disposed adjacent the second mirror.

In one embodiment, the plate reader is a fluorescence plate reader for detecting a fluorescence event (for example, fluorescence of a fluorescent dye) in the wells of the microtitre plate, in which the means for illuminating the wells of the microtitre plate is a light source, typically a UV light source, preferably having a peak wavelength of 370-390 nm, ideally about 380 nm.

Preferably, the light emitted by the wells of the microtitre plate is passed through a filter adapted to enrich the light in wavelengths that correspond to the excitation maxima of the fluorescent dye. Suitably, the filter is a 640-660 nm, ideally 650 nm, bandpass filter.

The invention also provides a system for detecting fluorescence intensity of light emitted from a well of a microtitre plate, the system comprising a microtitre plate reader according to the invention and a processor adapted to assign regions of light intensity on the digital image with coordinates of wells of the microtitre plate, and correlate regions of light intensity with fluorescence intensity.

Suitably, the step of assigning regions of light intensity on the image with coordinates of wells of the microtitre plate comprises the step of overlaying the digital image with a grid corresponding to the layout of wells in the microtitre plate, and then correlating the position of light intensity regions on the grid with the position of corresponding wells.

Typically, the region of light intensity is converted to a pixel value, and the pixel value is correlated with fluorescence intensity.

In a second aspect, the Applicant provides a system for detecting fluorescence intensity of light emitted by a well of a microtitre plate. The system comprises a microtitre plate reader that includes a camera, typically a cooled CCD camera, adapted to generate a digital image of the microtitre plate, and a processor adapted to assign regions of light intensity on the digital image with coordinates of wells of the microtitre plate, and correlate regions of light intensity with fluorescence intensity. Typically, the step of assigning regions of light intensity on the image with coordinates of wells of the microtitre plate comprises the step of overlaying the digital image with a grid corresponding to the layout of wells in the microtitre plate, and then correlating the position of light intensity regions on the grid with the position of corresponding wells.

Thus, the invention also provides a system for detecting fluorescence intensity of light emitted from a plurality of wells of a microtitre plate, the system comprising:
a plate reader body having a base, top and sidewalls, the top of the plate reader comprising at least one seat dimensioned for receipt of a microtitre plate, the at least one seat defining an aperature in the top of the plate that substantially corresponds to a base of the plate;
means for illuminating the plurality of wells of the microtitre plate with light from beneath the plate;
a camera and lens assembly for generating a digital image of the plurality of wells of the microtitre plate;
an optical system disposed within the plate reader body for imaging the plurality of wells of the microtitre plate onto the lens; and
a processor adapted to receive and process the digital image from the camera by overlaying the digital image of the microtitre plate with a grid defining areas of the image that correspond to the layout of the plurality of wells of the microtitre plate, and assigning a mean fluorescence intensity to each area of the image corresponding to a well of the microtitre plate.

Preferably, the processor is adapted to locate a center of each area of the image corresponding to a well of the microtitre plate, integrate a defined region in the centre, and generate a single rational integer which describes the mean fluorescence intensity within the well.

Typically, the system is for detecting changes in fluorescent intensity in a plurality of wells of a microtitre plate. In this embodiment, the camera and lens assembly is adapted to generate a plurality of sequential digital images of the plurality of wells of the microtitre plate, and the processor is adapted to process the sequential images and provide a signal (ideally a kinetic signal) indicative of the change in fluorescence intensity over time for each of the plurality of wells of the microtitre plate.

Suitably, the system is configured to generate digital images separated by a time period of 15 seconds to 15 hours, 15 seconds to 60 minutes, 1 to 30 minutes, 5 to 25 minutes, or 10 to 20 minutes. Thus, the system may be configured to generate a digital image every 15 seconds to 60 minutes, typically every 1 to 30 minutes, preferably every 5 to 25 minutes, and ideally every 10-20 minutes.

Suitably, the processor is adapted to generate on a display module a graph of fluorescence intensity versus time for each of the plurality of wells. Typically, the processor is adapted to calculate an onset time for each graph, which is preferably the steepest part of the curve indicating the time point at which the flouresence intensity is changing most rapidly.

The invention also relates to a method of detecting fluorescence intensity of light emitted from a plurality of wells of a microtitre plate, which method employs a system according to the invention in which a base of a microtitre plate is illuminated with light, and in which the plurality of wells of the microtitre plate comprises a sample and a fluorescent dye, and in which the light typically comprises a wavelength that corresponds to an excitation maximum of the dye, the method comprising the steps of:
generating a digital image of the plurality of wells of the microtitre plate;
overlaying the digital image of the microtitre plate with a grid corresponding to the layout of the wells of the microtitre plate; and
assigning a mean fluorescence intensity to each part of the image corresponding to a well of the microtitre plate.

Preferably, the method comprises a step of locating a center of each area of the image corresponding to a well of the microtitre plate, integrating a defined region in the centre, and generating a single rational integer which describes the mean fluorescence intensity within the well.

Typically, the method is for detecting changes in fluorescent intensity in a plurality of wells of a microtitre plate. In this embodiment, the camera and lens assembly generates a plurality of sequential digital images of the plurality of wells of the microtitre plate, and the processor processes the sequential images and provides a signal (ideally a kinetic signal) indicative of the change in fluorescence intensity over time for each of the plurality of wells of the microtitre plate.

Suitably, the method involves generating (suitably on a display device such as a computer screen) a graph of fluorescence intensity versus time for each of the plurality of wells. Typically, an onset time is calculated for each graph, which is preferably the steepest part of the curve indicating the time point at which the fluoresence intensity is changing most rapidly.

Suitably, the system is configured to generate digital images separated by a time period of 15 seconds to 15 hours, 15 seconds to 60 minutes, 1 to 30 minutes, 5 to 25 minutes, or 10 to 20 minutes. Thus, the system may be configured to generate a digital image every 15 seconds to 60 minutes, typically every 1 to 30 minutes, preferably every 5 to 25 minutes, and ideally every 10-20 minutes.

Preferably, a plurality of digital images are generated over a period of time, and a graph generated plotting fluorescence intensity over time.

Ideally, a graph is generated plotting fluorescence intensity over time for each well of the microtitre plate.

The invention also provides a high-throughput method for enumerating thermoduric bacteria in a plurality of samples comprising the step of pasteurising the samples, incubating each of the pasteurised samples and a fluorescent dye in a well of a microtitre plate for an incubation period, monitoring changes in fluorescence intensity in the plurality of wells over time according to a method of the invention, and for each of the plurality of wells correlating the change in fluorescence intensity over time with thermoduric bacterial number.

The invention also provides a computer program comprising program instructions for causing a computer to perform the method of the invention.

Preferably, the computer program is embodied on a record medium, a carrier signal, or a read-only memory.

In this specification, the term “plate reader body” refers to that part of a plate reader that generally includes the optical detection system. It is generally comprises four sidewalls, but may in certain embodiment comprise more or less than four sidewalls. The top of the plate reader body generally includes a seat for receipt of a microtitre plate, and in some embodiments, comprises more than one seat. Generally, the seat defines an aperture which allows passage of light emitted by the wells of the microtitre plate pass through.

In this specification, the term “microtitre plate” or “microplate” should be understood to mean a plate having a multiplicity of small wells for receiving samples. Generally, such plates have at least 6, 10, 20, 30, 40, 50, 60, 70, 80, or 90, 96, 192, 288, 384 or 1536 wells. Each well generally has a volume of less than 5 ml, 4 ml, 3 ml, 2 ml or 1 ml.

The term “regions of light intensity” refers to regions of the digital image having increased light intensity relative to the rest of the digital image. They correspond to wells of the microtitre plate that are emitting light, generally fluorescent light.

The term “distance to image plane of light” also referred to as ‘object distance’ refers to the distance that light emitted by the wells of the microtitre plate has to travel to reach the lens.

The term “mirror” should be understood to mean a reflecting surface adapted to reflect light emitted by the wells of the microtitre plate. Preferably, the mirror is adapted to achieve transmission at UV wavelengths. A suitable mirror is a UV transmitting light shaping diffuser surface.

In this specification, the term “CCD camera” should be understood to mean a charge coupled device camera, the details of which will be well known to those skilled in the art. Preferably, the camera is a cooled CCD camera. A suitable camera is a QSI 616 model made by QSI-Imaging.

The term “pixel value” refers to a rational integer associated with individual picture elements or ‘pixels’ which describes how bright that pixel is. The range of pixel values that it is possible to assign to a pixel is defined by the pixel depth of the image. In an image with 8-bit pixel depth, each pixel can have any value between 0 and 255.

In this specification, the term “fluorescence microtitre plate reader” should be understood to mean an instrument adapted to receive a microtitre plate and detect fluorescence events occurring in the wells of the microtitre plates. Generally, such readers will include a first optical system adapted to illuminate the samples in the wells with light of a specific wavelength (excitation wavelength), and a second optical system (emission system) that collects the emitted light, separated it from the excitation light with a suitable filter, and then measures the signal using a light detector. Examples of suitable light detectors are photomultiplier tubes, the details of which will be well known to those skilled in the art. Examples of fluorescence microplate readers include DTX 800 Multimode Detector (Beckman Coulter), Mithras Microplate Reader LB 940 (Berthold Technologies), and FLx800 Fluorescence Microplate Reader (BioTek Instruments).

In this specification, the term “fluorescent dye” should be understood to mean a dye that absorbs light of a specific wavelength and emits light of a different wavelength, and which is capable of being quenched by oxygen. Preferably, the fluorescence dye has a stokes shift of at least 200 nm, 220 nm, 24 nm, 250 nm, 260 nm or 270 nm. Examples of suitable fluorescent dyes include the GREENLIGHT™ fluorescent dyes sold by Moqom Inc. and Luxcel Biosciences Limited.

The term “sample” should be understood to mean any sample in which a fluorescent event is being monitored through quenching or unquenching of the fluorescent dye by changes of oxygen levels in the sample. A suitable example is detection or quantification of aerobic bacteria in samples, for example samples of food, where growth of bacteria leads to a decrease in oxygen levels caused by bacterial respiration, resulting in unquenching of the fluorescent dye and an increase in fluorescence intensity. Preferably, the sample is milk.

In this specification, the term “thermoduric bacteria” should be understood to mean bacteria which are capable of surviving pasteurisation conditions and carrying over into the milk and milk-products derived therefrom. Examples of thermoduric bacteria include species of micrococcus, streptococcus, and lactobacillus.

In this specification, the term “pasteurisation” in the context of milk should be understood to mean the heat treatment of a milk sample to slow the growth of food spoilage microorganisms. HTST pasteurisation involves heating the milk to about 71° C. for a period of 10-15 second. UHT pasteurisation involves heating the milk to 135° C. for at least 1 second.

In this specification, the term “heating block” should be understood to mean those devices that are specifically adapted to receive microtitre plates and heat samples contained in the wells of the microtitre plates. An example of a heating block in the context of the present invention is a PCR thermocycler. These devices are generally capable of heating samples to very precise heating specifications, and are ideally suited for use with the method of the invention.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

### BRIEF DESCRIPTION OF THE FIGURES

The invention will be more clearly understood from the following description of some embodiments thereof, given by way of example only in which:

FIG. 1 is a perspective view of a microtitre plate reader according to the invention with the front sidewall removed;

FIG. 2 is perspective view of a top of the plate reader of FIG. 1;

FIG. 3 is a rear elevational view of the plate reader of FIG. 1;

FIG. 4 is a further perspective view of the plate reader of FIG. 1

FIGS. 5 and 6 are views of a light guide adapted to guide light from the second mirror to the lens of the plate reader of FIG. 1

### DETAILED DESCRIPTION OF THE INVENTION

### EXAMPLE 1

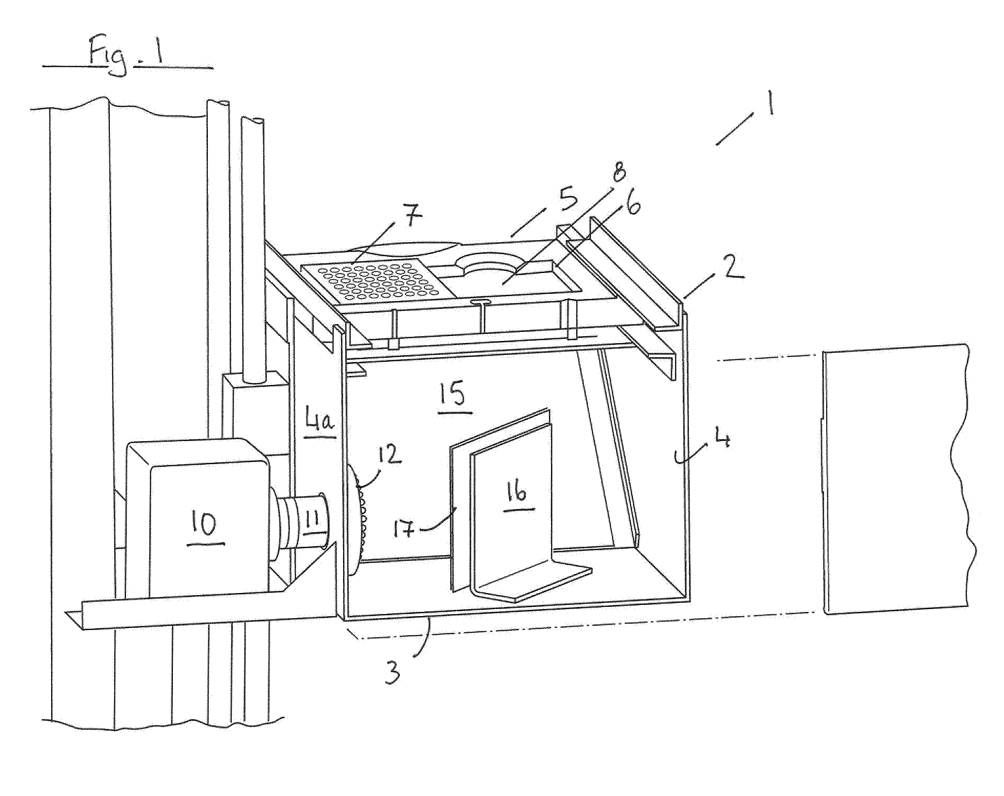

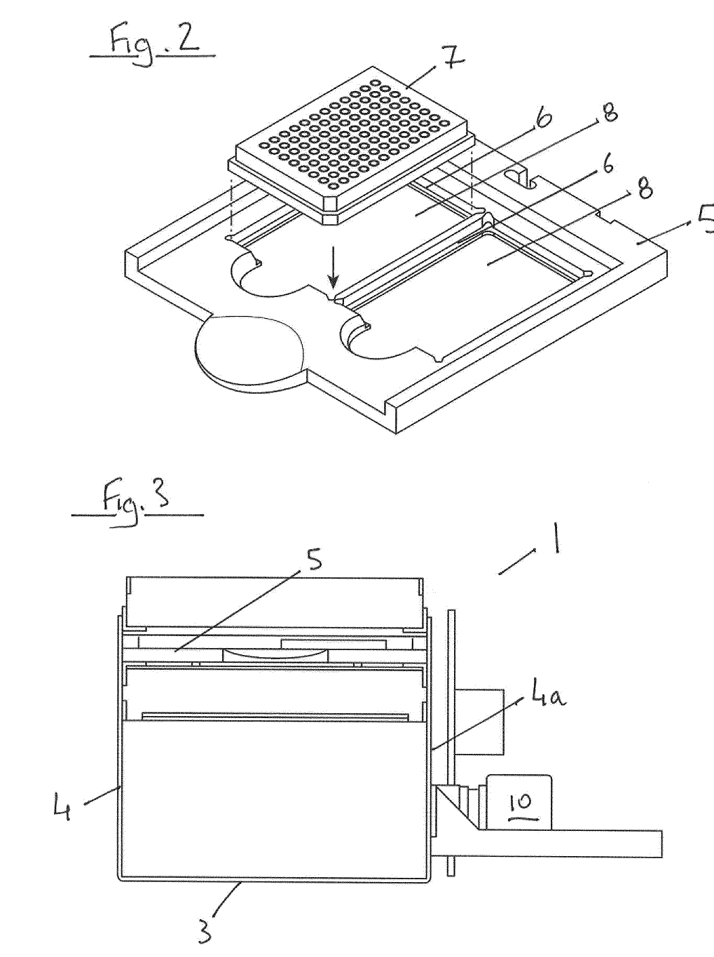

Referring to the figures, and initially to FIGS. 1 to 4, there is illustrated a fluorescence plate reader according to the invention, indicated generally by the reference numeral 1. The plate reader comprises a body 2 having a base 3, side walls 4 and a top 5 including two seats 6, each of which is adapted to receive a 96-well microtitre plate 7. In FIG. 1, a 96-well microtitre plate 7 is shown seated in one of the seats, and the second seat is not occupied. Each seat 6 defines an aperture 8 which allows light pass from the microtitre plate into and out of the plate reader body.

An air cooled QSI 616 CCD camera 10 (QSI Imaging) and CF12.5HA-1 fixed focal length lens 11 (Fujinon) are mounted in the sidewall 4a, with an LED ringlight (type-R LED Ringlight sold by SPECBRIGHT) 12 mounted to the sidewall 4a around the lens 11 (see FIG. 4). An optical system is provided in the body 3 to direct illumination light from the LED ringlight 12 to a base of the plate 7 and for directing light emitted from the wells of the plate to the lens 11 and camera 10. The optical system comprises mirrors 15, 16, formed by LSD™ UV transmitting light shaping diffuser surfaces. The first mirror 15 is disposed underneath the microtitre plate 7 and is oriented to direct light emitted from the base of the wells of the plate 7 sideways towards the second mirror 16. The second mirror 16 is oriented at an angle to direct light incident from the first mirror 15 sideways towards the lens 11 and camera 10. An EDMUND OPTICS 650 nm bandpass filter 17 is provided over the second reflector.

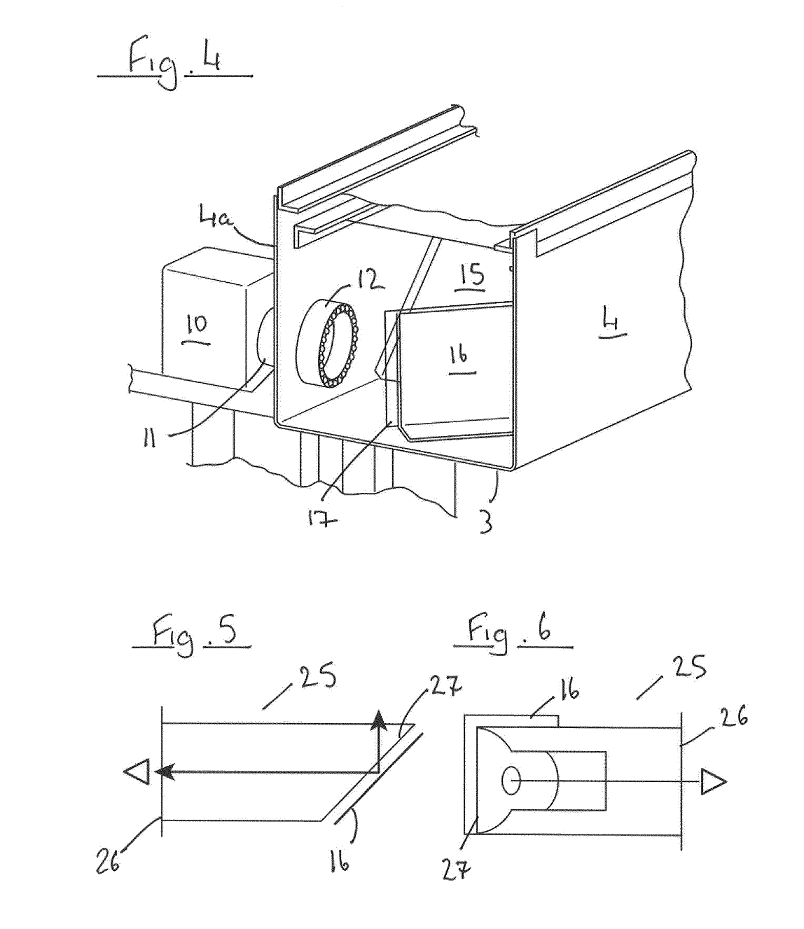

Referring to FIGS. 5 and 6, an alternative embodiment of the invention will now be described in which parts identical to those described with reference to the previous embodiment will be assigned the same reference numerals. In this embodiment, a baffle 25 is provided to guide light from the second mirror 16 to the lens 11 and prevent light emitted from the plate propagating directly to the lens. The baffle comprises a cylindrical tube having a first end 26 that embraces the ringlight 12 and a second frustoconical end 27 that is disposed adjacent the filter 17.

The image is captured by the camera using a 10 sec exposure time and an aperture setting of 5.6. The image is stored in a proprietary format with a pixel depth of at least 12 bits. The image is overlayed with an 8×12 grid reflecting the layout of the 96 sample wells on the plate. This grid is used to define the positions of the sample wells and thus the area of the image to be processed. Each well is defined individually from the overlaid grid and the centre of the well located, a defined area in the centre of the well is then integrated, yielding a single rational integer which describes the mean fluorescence intensity within the well. Images are taken at 15 min intervals and subject to this process each time. The mean intensity of the well is plotted against time yielding a sigmoidal curve, the first derivative of this curve is then calculated. The peak value in this derivative curve represents the peak rate of change of the sigmoid, which corresponds to the steep midpoint. The midpoint is then designated as the ‘onset time’ which is then correlated back through a standard curve to cfu/ml values.

### EXAMPLE 2

A fluorescence plate reader of the invention may be employed to quantify the thermoduric bacterial load of a sample of milk. The process involves an initial step of preparation of the microtitre plate. In this example, a 96 well microtitre plate is employed. Two 200μ aliquots of each sample of milk are taken, and each aliquot applied to a well of the plate. An aliquot of fluorescent dye, Greenlight Dye (Luxel Biosciences Limited), 4× standard proprietary working concenration is added to each well. This dye has an absorption maximum of 380 nm and an emission maximum of 650 nm, thus having a broad stokes shift of 270 nm. Once the milk samples and dye have been added to the plate, mineral oil is added to the top of each well 100 ul.

The microtitre plate containing the test samples is then placed into a PCR thermocycler device, in this case TECHNE TC-5000, and the device is set to heat the samples to a temperature of 71.7° C. for 15 seconds (or 63° C. for 30 mins) to pasteurize the milk. Once pasteurized, the samples are allows to cool before the microtitre plate is placed in a fluorescence plate reader (described in more detail below).

The wells of the plate are illuminated with UV light of 380 nm using a SPECBRIGHT™ LED ringlight Code R. Light emitted is reflected off the two mirrors, and passed through an EDMUND OPTICS 650 nm bandpass filter to filter out the illumination light, and concentrate light of the emission wavelength. The light is then passed through a fujinon CF12.5HA-1 fixed focal length lens, which focuses and directs the light emitted by the wells to a camera, in this case a QSI 616 cooled CCD camera. The camera generates a digital image comprising a plurality of dots in which each dot corresponds to a single well. The image is captured by the camera using a 10 sec exposure time and an aperture setting of 5.6. The image is stored in a proprietary format with a pixel depth of at least 12 bits. The image is overlayed with an 8×12 grid reflecting the layout of the 96 sample wells on the plate. This grid is used to define the positions of the sample wells and thus the area of the image to be processed. Each well is defined individually from the overlaid grid and the centre of the well located, a defined area in the centre of the well is then integrated, yielding a single rational integer which describes the mean fluorescence intensity within the well. Images are taken at 15 min intervals and subject to this process each time. The mean intensity of the well is plotted against time yielding a sigmoidal curve, the first derivative of this curve is then calculated. The peak value in this derivative curve represents the peak rate of change of the sigmoid, which corresponds to the steep midpoint. The midpoint is then designated as the ‘onset time’ which is then correlated back through a standard curve to cfu/ml values.

The invention is not limited to the embodiments hereinbefore described but may be varied in both construction and detail.

1. A microtitre plate reader for detecting fluorescence of a fluorescent dye in the wells of a microtitre plate, the microtitre plate reader comprising:
a plate reader body (2) having a base (3), top (5) and sidewalls (4), the top of the plate reader body comprising at least one seat (6) dimensioned for receipt of a microtitre plate (7), the at least one seat defining an aperature (8) that substantially corresponds to a base of the plate;
means for illuminating wells of a microtitre plate with light from beneath the plate;
a camera (10) and lens (11) assembly for capturing light emitted by the wells of the microtitre plate and generating a digital image, in which regions of light intensity of the image correspond to wells of the microtitre plate; and
an optical system disposed within the plate reader body for expanding the distance to image plane of light and comprising at least two mirrors (15, 16),
characterised in that the means for illuminating the wells of the microtitre plate comprises a ring light (12) that embraces the camera and lens assembly.

2. A microtitre plate reader as claimed in claim 1 in which the ring light (12) embraces the lens (11).

3. A microtitre plate reader as claimed in claim 1 in which the ring light (12) is a LED ring light.

4. A microtitre plate reader as claimed in claim 1 in which the ring light is a UV-emitting LED ring having a peak wavelength of 370-390 nm.

5. A microtitre plate reader as claimed in claim 1 in which the camera (10) and ring light (12) are disposed on or adjacent to a sidewall (4) of the plate reader body (2).

6. A microtitre plate reader as claimed in claim 1 in which the optical system consists of two mirrors (15, 16).

7. A microtitre plate reader as claimed in claim 1 in which the first mirror (15) is disposed to receive light from the wells of the microtitre plate (7) and reflect the light to a second mirror (16) which is disposed to reflect incident light to the camera lens (11).

8. A microtitre plate reader as claimed in claim 1 in which the camera is a cooled CCD camera.

9. A microtitre plate as claimed in claim 1 in which the illumination light and emitted light is substantially co-axial and substantially co-extensive.

10. A microtitre plate reader as claimed in claim 1 in which the plate reader body comprises a baffle (25) adapted to confine the light entering the lens to that reflected off the second mirror (16).

11. A microtitre plate reader as claimed in claim 10 in which the baffle (25) comprises a tube one end of which (26) is positioned adjacent the lens and a second end of which (27) is disposed adjacent the second mirror.

12. A microtitre plate reader as claimed in claim 1 and including a filter (17) configured to enrich light emitted by the wells of the microtitre plate in wavelengths that correspond to the excitation maxima of the fluorescent dye.

13. A microtitre plate reader as claimed in claim 12 in which the filter is a 640-660 nm bandpass filter.

14. A system for detecting fluorescence intensity of light emitted from a well of a microtitre plate, the system comprising a microtitre plate reader according to claim 1 and a processor adapted to assign regions of light intensity on the digital image with coordinates of wells of the microtitre plate, and correlate regions of light intensity with fluorescence intensity.

15. A system as claimed in claim 14 in which the processor is adapted to assign regions of light intensity on the image with coordinates of wells of the microtitre plate by means of overlaying the digital image with a grid corresponding to the layout of wells in the microtitre plate, and then correlating the position of light intensity regions on the grid with the position of corresponding wells.

16. A system as claimed in claim 14 in which the region of light intensity is converted to a pixel value, and the pixel value is correlated with fluorescence intensity.

17. A method of detecting fluorescence intensity of light emitted from a plurality of wells of a microtitre plate, which method employs a system according to claim 15 and a microtitre plate, in which a base of the microtitre plate is illuminated with light, and in which each of the plurality of wells of the microtitre plate comprises a sample and a fluorescent dye, and in which the light typically comprises a wavelength that corresponds to an excitation maximum of the dye, the method comprising the steps of:
generating a digital image of the plurality of wells of the microtitre plate;
overlaying the digital image of the microtitre plate with a grid corresponding to the layout of the wells of the microtitre plate; and
assigning a mean fluorescence intensity to each part of the image corresponding to a well of the microtitre plate.

18. A method according to claim 17, the method comprising a step of locating a center of each area of the image corresponding to a well of the plurality of wells, integrating a defined region in the centre, and generating a single rational integer which describes the mean fluorescence intensity within each of the plurality of wells.

19. A method as claimed in claim 17, in which the method is for monitoring changes in fluorescent intensity in a plurality of wells of a microtitre plate, in which the camera and lens assembly generates a plurality of sequential digital images of the plurality of wells of the microtitre plate, and the processor processes the sequential images and provides a kinetic signal indicative of the change in fluorescence intensity over time for each of the plurality of wells of the microtitre plate.

20. A high-throughput method for enumerating thermoduric bacteria in a plurality of samples comprising the step of pasteurising the samples, incubating each of the pasteurised samples and a fluorescent dye in a well of a microtitre plate for an incubation period, monitoring changes in fluorescence intensity in the plurality of wells over time according to a method of claim 19, and for each of the plurality of wells correlating the change in fluorescence intensity over time with thermoduric bacterial number.
